(19) United States
(12) Patent Application Publication
(10) Pub. No.: US 2026/0060872 A1
(43) Pub. Date: Mar. 5, 2026

(54) FREEZING OF GAIT ASSIST DEVICE

(71) Applicant: Richard L. Murchison, Federal Way, WA (US)

(72) Inventor: Richard L. Murchison, Federal Way, WA (US)

(21) Appl. No.: 18/823,119

(22) Filed: Sep. 3, 2024

(51) Int. Cl. A61H 3/00

(52) U.S. Cl. CPC A61H 3/00

(57) ABSTRACT

The presently disclosed device for assisting an individual experiencing freezing of gait includes a flexible lead material of approximately three to four feet in length to which is attached a rigid portion of approximately five to eight inches. Preferably, the device has a first end that includes a loop or handle; a flexible material of three to four feet in length, and a second end of rigid material of five to eight inches in length.

### FIELD

The present invention relates in general to a device that provides assistance with walking to patients who experience freezing of gait.

### BACKGROUND

Parkinson's disease has been recognized as the second most common neurodegenerative disease in the United States. One of the most common and debilitating symptoms of Parkinson's disease is freezing of gait (FOG), which is also referred to as sticky feet. Freezing of gait can be defined as a sudden onset of immobility, or the temporary, involuntary inability to move. Freezing of gait is an abnormal gait pattern that can accompany Parkinson's disease as well as other parkinsonian disorders in which there are sudden, short and temporary episodes of an inability to move the feet forward despite the intention to walk. Parkinson's patients describe the sensation of FOG as feeling like their feet are “glued to the floor”. This symptom not only causes great fear, anxiety, and decreased quality of life, but also is a leading cause of falls for people with Parkinson's. For some, there is brief trembling of the feet in place followed by short, small steps, while others experience total immobility and are unable to move at all for a few moments.

There are various devices currently available to assist patients with freezing of gait by promoting a patient to take a first step followed by subsequent steps. Sensory cues, including visual cues, have been researched and shown to be effective in helping patients overcome FOG. A commonly used visual cue is provided by a device that emits one or more laser line(s) that run in parallel on the surface/floor by a person's feet. In use, patients are directed to step over the line in front of the patient that is projected by the laser system. One popular system emits a green laser line or series of green laser lines on the ground surface in front of a patient's feet.

Although there are devices such as the laser line that can assist patients with FOG, such devices can have limitations such as not being effective in bright light or bright outdoor light; they can be complicated systems that require a power source for use; they can be relatively expensive; and so forth. Accordingly, there remains a need in the art for a relatively uncomplicated, easy to use, and inexpensive device that assists patients who experience FOG. The presently described device fulfills these needs.

### SUMMARY

The presently disclosed device is directed to assisting users and patients in need thereof of overcoming freezing of gait (FOG; also referred to as “sticky feet”) issues. The device may be recognized commercially by the terminology “Drop & Step,” for which a US trademark application has been submitted. FOG is one of several physical issues experienced by patients with Parkinson's or related neurological conditions/diseases. FOG results from a patient's perception or sensation that their feet are stuck to the ground or floor, such that they cannot move them. One means of assisting individuals with FOG is to provide a device or implement that provides a target line for a person experiencing FOG to step over. The target line triggers a neurological response that allows a person experiencing FOG to take a step forward. Typically, once an individual experiencing FOG takes a first step, the individual gains momentum that allows them to move forward with subsequent steps.

In particular, the device described herein provides an individual experiencing FOG with an inexpensive, easy to use device for taking a first step. The device comprises a lead of cord, rope, or similar flexible material with a length of three to four feet which culminates with a rigid portion at one end of the flexible material. The rigid portion of material is designed to be placed on the ground or floor in front of an individual experiencing FOG so as to provide a target for the person to step over.

In use, the individual simply holds a first end of the flexible material and places the other, second end of the device (with the rigid portion) on the ground surface or floor by dropping the rigid portion on the ground surface. The individual then steps over the rigid section of the device to initiate a first step and enable the individual to walk. The individual next simply picks up the device as they continue to walk forward. The individual then holds the device until it is needed again.

The presently disclosed device is described in more detail in the following figures and detailed description. Other embodiments of the present invention will become readily apparent to those skilled in the art from the following detailed description. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive or limiting.

### BRIEF DESCRIPTION OF DRAWINGS

FIG. 1 shows an embodiment of a presently disclosed FOG assist device.

FIG. 2 shows an embodiment of a presently disclosed FOG assist device.

FIG. 3 shows an embodiment of a presently disclosed FOG assist device.

FIG. 4 shows an embodiment of a presently disclosed FOG assist device.

### DETAILED DESCRIPTION

The presently disclosed device is directed to assisting individuals experiencing FOG (also referred to as sticky feet) with the ability to walk. The device comprises a flexible material such as cord, rope, string, leather, and so forth that is approximately three to four feet in length that culminates in an end section that contains a rigid material of approximately five to eight inches in length. While these suggested lengths are exemplary embodiments, the device is not limited to these dimensions, such that other variations of the device are further contemplated.

The presently disclosed device provides a method of assisting a patient experiencing FOG with the ability to walk. The device is used by a patient to provide a target to step over, which triggers the ability to take a step by a patient who experiences FOG. In use, the patient holds a first end of the device and drops a second end of the device in front of the patient's feet. The second end includes the rigid portion of the device, which provides a target to step over when the rigid portion of the device is dropped in front of the patient's feet. Once the target has been placed in front of the patient's feet, the patient steps over the rigid portion of the device to initiate walking. The user then picks up the rigid portion of the device as the patient continues to walk forward. Upon stopping, the patient can repeat the process to initiate walking and overcoming FOG. In between repeated uses, the device can be held by the patient and/or draped over the patient's shoulder for convenient subsequent use. When a patient will not be walking again for a while, the device can easily be kept or stored on a table, chair, coat rack, and so forth to keep it conveniently close for later use when the patient wishes to walk again.

In a preferred embodiment, the presently disclosed device comprises a flexible material such as cord, paracord, rope, string, leather and so forth that provides a lead. In a preferred embodiment, the lead material is washable so that it can be periodically washed between uses. The lead is constructed to be lightweight so that it is easy to use and easily carried by a user. The flexible material will typically be approximately three to four feet in length and have a cross-section or width/thickness that ranges from approximately 0.25 inches to 0.5 inches, and upwards to 0.75 or 1 inches thick. These dimensions are non-limiting, exemplary embodiments. Other dimensions that enable or provide a convenient to use device are also contemplated as variations of the presently disclosed device. The length of the lead provides a convenient length between a patient's hand and the ground surface, so that the patient can easily drop the rigid portion to lie flat in front of their feet while the flexible lead hangs down from the patient's hand. The lead is designed to be convenient to use and also unobtrusive to enable a user to readily carry the device, place the device over a user's shoulder, and so forth between uses.

The lead of the device preferably has a first end to which a loop or handle is attached; a three-to four-foot-long body segment of flexible material; and a second end of the lead to which a rigid section approximately five to eight inches is attached. These dimensions are non-limiting, exemplary embodiments. Other dimensions that enable or provide a device that provides a target for a first step towards enabling an individual experiencing FOG are also contemplated as variations of the presently disclosed device.

The presently disclosed device provides a user with a target to step over that is defined by the length, width, and height of the rigid portion of the device. Accordingly, the rigid end material preferably may be approximately five to eight inches in length but is not limited to that length. Any length of rigid material that provides an adequate target to step over may be employed in the device, including, but not limited to, lengths from 3 to 12 inches; 5 to 10 inches; 6 to 8 inches; and so forth.

In a preferred embodiment, the width of the rigid portion of the device is approximately 0.5 to 1.25 inches wide but is not limited to this width. Accordingly, the width of the rigid portion may vary from as little as 0.25 inches to as much as 2 inches wide. The width represents a target size that is approximately placed perpendicular to the front of a user's foot, such that the user will step over the width. While the device may incorporate rigid portions greater than 2 inches wide, such greater widths may compromise the utility of the device, depending on a given user's ability to readily step over a wider rigid portion of the device. In addition, the target will often land on the surface at an angle relative to the user's foot when the rigid portion is set down in front of a person. Accordingly, the width and length of the rigid portion can inhibit the utility of the device if the width and length of the rigid portion is too great and/or presents a possible tripping hazard.

The height of the rigid portion of the device also contributes to the utility of the device. In a preferred embodiment, the height of the device is 0.125 to 0.25 inches high, but is not limited to these heights. While the device may incorporate rigid portions that are greater than 0.25 inches high (such as 0.3 inches, 0.4 inches, and so forth), such greater heights may compromise the utility of the device, depending on a given user's ability to readily step over a higher/taller rigid portion of the device. A rigid portion that is either too wide or too tall can compromise the utility of the device and unintentionally create a tripping hazard.

The presently disclosed device provides a target for a user to step over. Accordingly, the shape of the rigid portion of the device contributes to its utility. In a preferred embodiment, the rigid portion of the device has a generally rectangular shape (when viewed from above and placed on a walking surface) that provides a generally linear target for a user to step over. Other shapes that might provide similar utility are also contemplated, and include, but are not limited to, triangular shapes; rhomboid shapes, and partially circular shapes. Preferably, the rigid portion of the device provides a straightforward target for the user to step over and will likely include a straight or approximately straight edge for a user to step over.

In addition to its outer shape as perceived from above, the presently disclosed rigid portion of the device can have any of a number of potential cross-sectional shapes that define the height of the device (as viewed from an end of the rigid portion of the device when it lies flat on a surface). Such shapes include, but are not limited to, rectangular, triangular, rhomboid, circular, and so on. Accordingly, the rigid portion of the device can be constructed from rectangular material, triangular material, rhomboid material, circular material (such as a circular rod), and so on.

The device has a light weight so that a user can comfortably hold and carry the device as well as use it. The rigid portion of the device has enough weight to it such that it will naturally hang below the flexible material of the device when the device is held off the ground surface. While the primary function of the device is to provide a visual target for a user to step over, the audible sound of the rigid portion hitting the ground surface may also contribute to the effectiveness of the device. Accordingly, the rigid portion of the device has a weight that contributes to the use of the device in which a user places or drops the device down in front of their feet and also hears the rigid portion hitting the ground/walking surface. The rigid portion will therefore have a weight that ranges from one to several ounces, such as one to two, three, four, five, six, seven, or eight ounces. The weight of the rigid portion is not limited to these preferred ranges. Accordingly, rigid sections having greater weights are also contemplated as variations of the presently disclosed device.

The rigid portion of the device can be constructed from any of a number of materials, including a metal (such as aluminum, brass, stainless steel, and so forth), a plastic, a hardened rubber, a resin, fiberglass, carbon fiber, and so on. Preferably, the rigid portion is made of a non-corrosive or corrosive-resistant material that can withstand exposure to water, cement, asphalt, salt and other corrosive materials (such as those used in icy or snowy conditions), dirt, turf, and so forth. In addition, the rigid portion is made of a durable material that can withstand being repeatedly dropped onto a walking surface, such as a floor, cement, carpet, turf, gravel, and so forth.

The presently disclosed device can be constructed in any of a number of ways that provides for a rigid portion attached to the lead portion made of a flexible material. Accordingly, the rigid portion of the device may be attached to the flexible lead material of the device by any of a number of attachment or fastening means. For example, the rigid material can include a hole used for attaching the rigid material to the flexible material, whereby the flexible material can be tied to the rigid material through the hole. Alternatively, an end of the flexible material can include a clip, swivel hook, j-hook, or similar fastener attached to it, such that the rigid material can be clipped onto or similarly fastened to the flexible material. In this manner, the fastener would preferably rotate 360 degrees to allow the rigid portion to freely rotate when in use.

The rigid portion of the device may include a bare material that is attached to the flexible material of the lead of the device or alternatively, a covered material in which the underlying bare material is covered in total or in part by an outer material. In a preferred embodiment, the rigid portion of the device is covered by an extension of the flexible material of the lead of the device. For example, a lead comprised of a cord could have an extension of cord (or a sub-component or sub-fiber of the cord) that wraps around the bare material of the rigid portion to both cover or encase the bare material and attach the bare, rigid material to the lead of the device.

Alternatively, the bare material of the rigid portion could be covered by a material that is separate from the flexible material that comprises the lead of the device. For example, the bare material could be covered by a cord, rope, cloth or a fabric material. In this manner, the bare material could be encased by an outer material that is permanently mounted to the bare material or alternatively a removeable outer material that the bare material is placed into (in a manner akin to how a sock fits over a foot). The bare material could also be coated with an outer material, such as a bare metal that is coated with a plastic, a rubberized material, a resin, a fibrous material, and so forth.

In another preferred embodiment, the rigid material can include a number of holes through which flexible material is woven. In this manner, a woven pattern of flexible material can be incorporated into and around the rigid material, such as parallel rows of flexible material that overlay the rigid material, a crisscross pattern of flexible material, and so on. The woven flexible material accordingly would partially cover the rigid material as a raised surface of flexible material over the surface of the rigid material, such that the woven flexible material directly contacts the ground surface to which the device is placed by a user.

In a preferred embodiment, the flexible material of the device is made of reflective material or is coated with a reflective material. In this manner, the flexible material of the device, and accordingly, the entire device, are easier to locate in low light or near dark conditions. The flexible material can be made of a reflective material such as reflective cord, rope, string, and so forth that brightly reflects light. The reflective material can have fluorescent properties, and be made of fluorescent colors such as green, yellow, orange, light blue, red, white, and so forth. The flexible material can be made entirely of reflective material, such as reflective nylon, polyester, or other reflective polymers, or a combination of a reflective material and non-reflective material. For example, the flexible material can contain a reflective cord material that is intertwined/interwoven with a non-reflective material to produce a reflective, flexible material.

Alternatively, the flexible material can be yielded reflective by coating a non-reflective material with a reflective material. For example, a non-reflective cord or rope can be coated with a reflective paint, reflective adhesive, and so on to create a permanently reflective, flexible material.

In addition to having a reflective, flexible material, a preferred embodiment of the device may be made of or coated with a glow-in-the-dark material. In this embodiment, the flexible material will have fluorescent properties that enable the device to be visualized in little light or essentially in a completely dark environment, such as a bedroom at night. The glow-in-the-dark material will enable a user to see the device without the assistance of a light in low light or dark conditions. For example, a user who wakes up in the middle of the night would be able to locate and use the device in a dark environment before turning on a light. As per the reflective material described above, the flexible material may incorporate glow-in-the-dark material via the entire flexible material being made of glow-in-the-dark material or the flexible material being partially made of glow-in-the-dark material that is intertwined/interwoven with material that does not glow in the dark.

Likewise, a preferred embodiment of the device described herein alternatively can be yielded glow-in-the-dark by coating a non-glowing material with a glowing material. For example, a non-glowing cord or rope can be coated with a glowing paint, glowing adhesive, and so on to create a permanently reflective, flexible material that glows in the dark.

In a preferred embodiment, the presently disclosed device has a flexible lead material having a first end with a handle and a second end with a rigid portion. The handle can be constructed from the flexible lead material, such as a loop or flexible lead material that loops back on itself to form two or more layers that provide a thicker portion to serve as a handle. Alternatively, a separate material can be attached to the first end of the flexible lead material as a handle. For example, without limitation, a handle made of plastic, polymer, resin, wood, and so forth can be attached to the flexible material. The handle can have a cylindrical shape, rectangular shape, triangular shape, and so forth. In one embodiment, the handle has grooves or ridges on one side to form a handle that a user's fingers fit into when the device is held in use.

In a preferred embodiment, a FOG assist device includes an aesthetically pleasing cord, rope, string, leather, or similar material. Accordingly, FOG assist devices as contemplated herein can be made of any aesthetically pleasing material. Such material can display various color schemes that reflect various sports teams, organizations, and so forth.

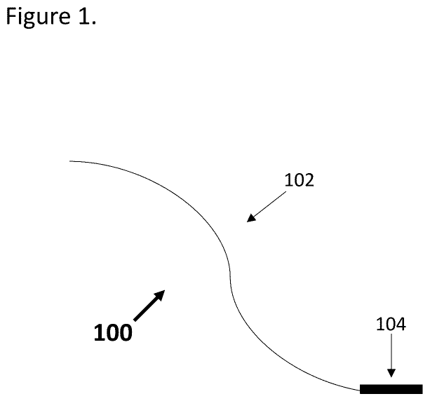

FIG. 1 provides an exemplary embodiment of a FOG assist device. As shown in FIG. 1, the device 100 comprises a flexible cord material 102 approximately three to four feet long; and a rigid section 104 that is approximately five to seven inches long (drawing is not to scale).

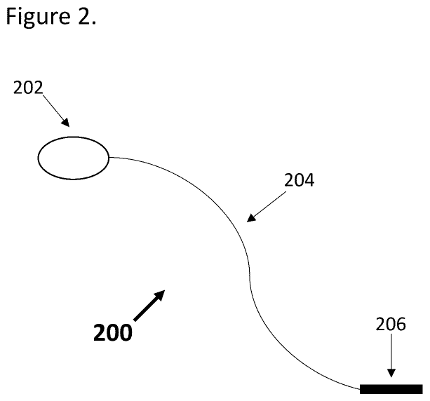

FIG. 2 provides yet another exemplary embodiment of a FOG assist device. In this preferred embodiment, the device 200 comprises a loop handle 202; a flexible cord material 204 approximately three to four feet long; and rigid section 206 approximately five to seven inches long (drawing is not to scale). In this embodiment, the rigid section 206 includes a rod, stick, or similar rigid material that is covered by/wrapped in cord material. In this manner, the rigid section 206 is fully contained by the cord material and also provides an aesthetically pleasing device.

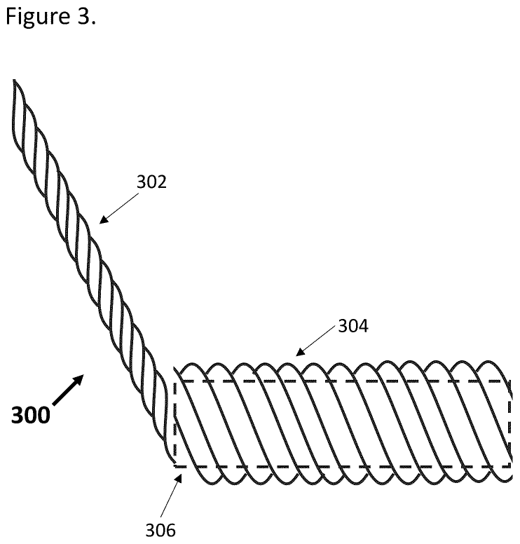

FIG. 3 provides a partial view of an exemplary embodiment of a FOG assist device. In this partial view, the device 300 comprises a flexible cord material 302 and a rigid portion 306 (depicted by a dotted line) that is wrapped and encased by the flexible cord material 304. The flexible cord material 302 wraps around the rigid portion 306 in the region designated 304, such that the flexible cord material both wraps the rigid portion 306 and also attaches the rigid portion 306 to the flexible cord 302.

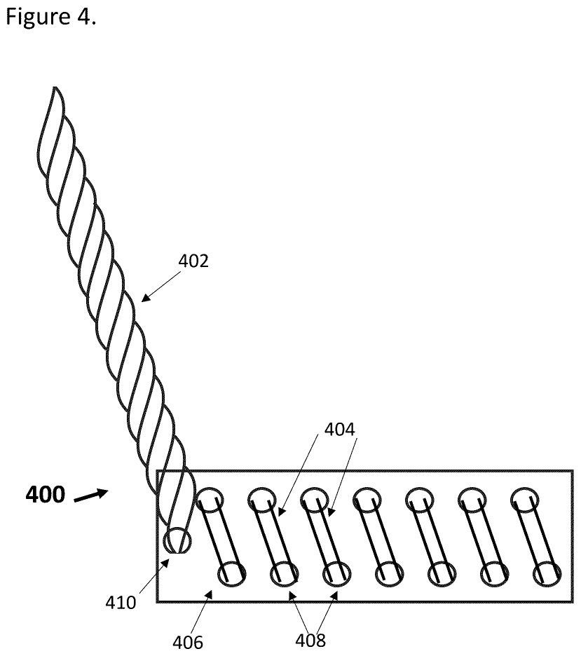

FIG. 4 provides a partial view of yet another exemplary embodiment of a FOG assist device. In this partial view, the device 400 comprises a flexible cord material 402 and a rigid portion 406 to which flexible cord material has been woven into and around the rigid portion 406. In particular, the rigid portion has a series of holes, exemplified by 408, through which flexible material has been woven, as exemplified by 404. In this exemplary embodiment, the woven flexible material 404 forms a series of parallel rows of flexible material that provide an outer cover to the rigid portion 406. This exemplary embodiment is not limiting, such that different interwoven patterns of flexible material on the rigid portion 406 are contemplated as variations of the device. In this exemplary embodiment, the flexible material of the lead 402 is tied to the rigid portion 406 through a hole 410 in the rigid material. This embodiment is not limiting, since any the flexible lead material 402 can be attached to the rigid portion by any of a number of means, such as direct tying (as shown), clips, swivel hooks, and other various fasteners that could be used to fasten the flexible lead material 402 to the rigid portion 406.

While the invention has been particularly shown and described as referenced to the embodiments thereof, those skilled in the art will understand that the foregoing and other changes in form and detail may be made therein without departing from the spirit and scope of the invention.

1-20. (canceled)

21. A device consisting of a flexible lead of three to four feet in length and a rigid linear step target attached to an end of the lead;
wherein the rigid linear step target has a hole at a first end, wherein the hole passes the first end to create a hole that traverses from a top surface to a bottom surface of the linear step target;
the flexible lead is attached to the rigid linear step target through the hole in the first end of the rigid linear step target;
the rigid linear step target is metal configured to provide an audible sound when the rigid linear step target is dropped on a hard surface; and
the rigid step target has a weight that ranges from 1 to 8 ounces.

22. The device of claim 21, in which the rigid linear step target consists of a length of five to eight inches.

23. The device of claim 21, in which the rigid linear step target consists of a width of 0.25 to 1.5 inches.

24. The device of claim 21, in which the rigid linear step target consists of a height of 0.125 to 0.25 inches.

25. The device of claim 21, in which the flexible lead is attached to the rigid linear step target by fastening flexible material that consists of a first end of the flexible lead to the rigid linear step target through the hole in the rigid linear step target.

26. The device of claim 21, in which the flexible lead is attached to the rigid linear step target by a fastener, wherein a first portion of the fastener is fastened to a first end of the flexible lead and a second portion of the fastener is fastened to the rigid linear step target through the hole in the first end of the rigid linear step target.

27. The device of claim 21, in which the flexible lead consists of a flexible material selected from the group consisting of cord, paracord, rope, string, and leather.

28. The device of claim 27, in which the flexible material further consists of a reflective material.

29. The device of claim 21, in which the rigid linear step target is consists of a non-corrosive, durable metal.

30. The device of claim 21, in which the rigid step target consists of a non-corrosive, durable metal.

31. A device consisting of a flexible lead of three to four feet in length, a handle attached to a first end of the flexible lead, and a rigid linear step target attached to a second end of the flexible lead;
wherein the rigid step target has a hole at a first end that traverses from a top surface to a bottom surface through the first end;
The rigid linear step target is metal that imparts an audible sound when dropped onto a hard surface; and
the second end of the flexible lead is attached to the rigid linear step target through the hole in the first end of the rigid step target.

32. The device of claim 31, in which the handle at the first end of the flexible lead consists of a loop of the flexible lead wherein a portion of the first end of the flexible lead loops back on itself.

33. The device of claim 31, in which the rigid linear step target comprises a length of five to eight inches.

34. The device of claim 31, in which the rigid linear step target comprises a width of 0.25 to 1.5 inches.

35. The device of claim 31, in which the rigid linear step target comprises a height of 0.125 to 0.25 inches.

36. The device of claim 31, in which the flexible lead is attached to the rigid linear step target by a fastener, wherein a first portion of the fastener is fastened to the second end of the flexible lead and a second portion of the fastener is fastened to the rigid linear step target through the hole in the first end of the rigid step target.

37. The device of claim 31, in which the flexible lead consists of a flexible material selected from the group consisting of cord, paracord, rope, string, and leather.

38. The device of claim 31, in which the rigid linear step target consists of a non-corrosive, durable metal.

39. The device of claim 38, in which the rigid linear step target consists of a non-corrosive, durable metal selected from the group consisting of aluminum, brass, nickel and stainless steel.

40. A device consisting of a flexible lead of three to four feet in length, a handle attached to a first end of the flexible lead, and a rigid linear step target attached to a second end of the flexible lead;
wherein the handle consists of a loop at the first end of the flexible lead formed from a portion of the first end of the flexible lead that loops back on itself,
wherein the rigid linear step target has a hole at a first end;
wherein the flexible lead is attached to the rigid linear step target by a fastener in which a first portion of the fastener is fastened to the second end of the flexible lead and a second portion of the fastener is fastened to the rigid step target through the hole in the first end of the rigid linear step target;
wherein the rigid step target is comprised of a non-corrosive, durable metal that imparts an audible sound when dropped onto a solid surface;
wherein the rigid linear step target has a rectangular shape;
wherein the rigid linear step target consists of a length of five to eight inches, a
width of 0.25 to 1.5 inches, and a height of 0.125 to 0.25 inches and
wherein the rigid linear step target comprises a weight that ranges from 1 to 8 ounces.
